(19) United States
(12) Patent Application Publication
(10) Pub. No.: US 2026/0064795 A1
(43) Pub. Date: Mar. 5, 2026

(54) CONTENT ADAPTIVE DATATYPE

(71) Applicants: Advanced Micro Devices, Inc., Santa Clara, CA (US); XILINX, INC., San Jose, CA (US)

(72) Inventors: Alireza KHODAMORADI, Lafayette, CO (US); Kristof DENOLF, Longmont, CO (US); Eric DELLINGER, Longmont, CO (US); Adam LI, San Diego, CA (US)

(21) Appl. No.: 18/818,702

(22) Filed: Aug. 29, 2024

(51) Int. Cl. G06F 17/10

(52) U.S. Cl. CPC G06F 17/10

(57) ABSTRACT

Embodiments herein describe a content adaptive array that can include different types of data. A compute unit can include conversion circuitry (e.g., upcast circuitry) that can identify the datatype(s) in the content adaptive array and convert the data so it has a desired datatype. For example, if the content adaptive array has both FP and INT, the upcast circuitry converts the data into the same datatype (e.g., FP8). If the array includes FP4 and FP8 (or INT4 and INT8), the upcast circuitry converts the data into FP8. This means the circuitry in the compute unit that performs the data operation (e.g., matrix multiplication) does not have to support many different types of datatypes.

### TECHNICAL FIELD

Examples of the present disclosure describe executing arrays used in, for example, machine learning (ML) applications that include different datatypes.

### BACKGROUND

ML and Artificial Intelligence (AI) models typically use large amounts of data in vectors, matrices, and tensors (referred to collectively herein as arrays). These data structure can be the input/output of the model, the model weights, the activations, or other data used in the computation (e.g., intermediate data). For ML applications (as well as other applications) the entire array (e.g., matrix, vector, or tensor) is in one datatype. For example, there can be floating point (FP) array (e.g., a FP32 array, an integer array (e.g., INT8 integer vector), etc. Once the datatype is chosen, the entire array is represented in that datatype. This enables downstream hardware (e.g., matrix multipliers) to either process the data in the array directly, or to convert the data in the array to a datatype that is compatible with the hardware and then process the data.

### SUMMARY

One embodiment described herein is a compute unit that includes encoding circuitry configured to receive an array where the array includes multiple data values and one or more type selector bits and the one or more type selector bits indicating a datatype of at least one of the data values. The compute unit further includes an FP converter including circuitry configured to convert floating point (FP) data values in the array to a desired datatype, an INT converter including circuitry configured to convert integer (INT) data values in the array to the desired datatype, and compute circuitry configured to perform a compute operation using the multiple data values after being converted into the desired datatype.

Another embodiment described herein is a compute system that includes memory configured to store an array where the array includes multiple data values and one or more type selector bits and the one or more type selector bits indicating a datatype of at least one of the data values. The compute system also includes a compute unit configured to receive the array from the memory, convert FP data values in the array to a desired datatype, convert INT data values in the array to the desired datatype, and perform a compute operation using the multiple data values after being converted into the desired datatype.

Another embodiment described herein is a method that includes receiving an array from memory where the array includes multiple data values and one or more type selector bits and the one or more type selector bits indicates a datatype of at least one of the data values. The method also includes upcasting FP data values in the array to a desired datatype, upcasting INT data values in the array to the desired datatype, and performing a compute operation using the multiple data values after being converted into the desired datatype.

### BRIEF DESCRIPTION OF THE DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 illustrates a block diagram of a ML compute system for compressing data using a content adaptive array, according to one embodiment.

FIG. 2 illustrates a one dimensional (1D) content adaptive array, according to one embodiment.

FIG. 3 illustrates a 1D content adaptive array that is divided into groups, according to one embodiment.

FIGS. 4 and 5 illustrate a two dimensional (2D) content adaptive array that is divided into groups, according to one embodiment.

FIG. 6 illustrates a 2D content adaptive array that is divided into groups with additional scale offsets, according to one embodiment.

FIG. 7 illustrates a 1D content adaptive array that is divided into groups with additional scale offsets, according to one embodiment.

FIG. 8 is a flowchart for upcasting data values in a content adaptive array, according to one embodiment.

FIG. 9 is a flowchart for bypassing upcasting in a compute unit, according to one embodiment.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the embodiments herein or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described

Embodiments herein describe a content adaptive array (e.g., a vector, matrix, tensor, etc.) that includes different types of data. As mentioned above, when a ML application is configured for execution, the datatypes are set (e.g., known or fixed). As such, the hardware knows what datatypes to expect, and is either delivered data it is compatible with, or is able to convert the data into a type it is compatible with. However, it may be advantageous to compress data (e.g., quantization data) into datatypes with fewer bits, especially when transmitting the data to or from memory. That is, when processing the data, to preserve accuracy, the ML system may want to process high-precision data (e.g., FP32), but when storing the data, it may be advantageous to compress the data (e.g., INT4, FP4, microscaling FP (MXFP4), block floating point (BFP4) etc.). This can save bandwidth, reduce memory usage, save power, and the like.

However, compressing the data in an array into the same datatype may result in some data values underflowing (which is just one example of a quantization error that may occur). These smaller datatypes often include a shared scale value. If the values in the array have a large dynamic range (e.g., the values have larger distributions), then converting from a FP32 to FP4/INT4/MXFP4/BFP4 can mean the data values at the lower ends of the distributions can underflow (e.g., be converted to zero) which means these data values are lost. As such, compressing all the data in an array into the same datatype can result in lost information.

Instead, the embodiments herein describe using content adaptive arrays where the datatype of the array can vary depending on the actual values of the data in the array. For example, for arrays where the data values have a small dynamic range (e.g., a tight distribution of values), an INT4 datatype may be preferred since it can provide the most accuracy and still avoid underflow. For arrays where the data values have larger dynamic ranges, an FP datatype may be preferred since it provides more dynamic range. However, since the datatype can change, the hardware (or software) tasked with processing the array might not know the datatype when it receives the array. That is, to hardware, an INT4 array can have the same size as a FP4 array even though the meaning of the data values is different. As such, the content adaptive array can include metadata (e.g., type selector bits) that indicates the datatype of the data in the array. Thus, when the hardware receives the array, it can use the metadata to identify the datatype of the data and then process the array accordingly (e.g., convert it to a different datatype it is compatible with). In this manner, the datatype in any array can change (i.e., adapt) according to the values of the data in the array.

In one embodiment, the content adaptive array can store multiple datatypes. For example, a first sub-portion of the array may have INT4 data values while a second sub-portion of the array has FP4 data values. For example, the first sub-portion may include data values with a small dynamic range making it better suited for INT4 while the second sub-portion includes data values with a higher dynamic range, making FP4 a better choice to avoid underflow. The metadata for the array can include at least one type selector bit for the first sub-portion and another type selector bit for the second sub-portion. The hardware receiving the array can use the type selector bits to identify the different datatypes in the array. In this manner, an array can include different datatypes within it, which can further improve accuracy of the ML operations.

However, permitting the datatypes in array to change over time (or using an array that has multiple different datatypes) introduces complications into the hardware that performs an operation using the array. The embodiments herein describe a compute unit with conversion circuitry (e.g., upcast circuitry) that can identify the datatype(s) in the content adaptive array and convert the data so it has a desired datatype. For example, if the content adaptive array has both FP and INT, the upcast circuitry converts the data into the same datatype (e.g., FP8 or some other higher precision datatype). If the array includes FP4 and FP8 (or INT4 and INT8), the upcast circuitry converts the data into FP8. This means the circuitry in the compute unit that performs the data operation (e.g., matrix multiplication) does not have to support many different types of datatypes. The can reduce the amount of circuitry used, as well as improve the throughput of the compute unit.

In one embodiment, if the compute unit is instructed to perform an operation using data that is already the same type (e.g., multiplying weights and activations that are both INT4 or both FP4), the compute unit may perform this operation without upcasting. That is, the compute unit may bypass the upcasting circuitry to directly perform the operation using the data as it is received from memory. The data may also correspond to a shared minimum value, which can be accounted for after the operation (e.g., after the matrix multiplication) has been completed.

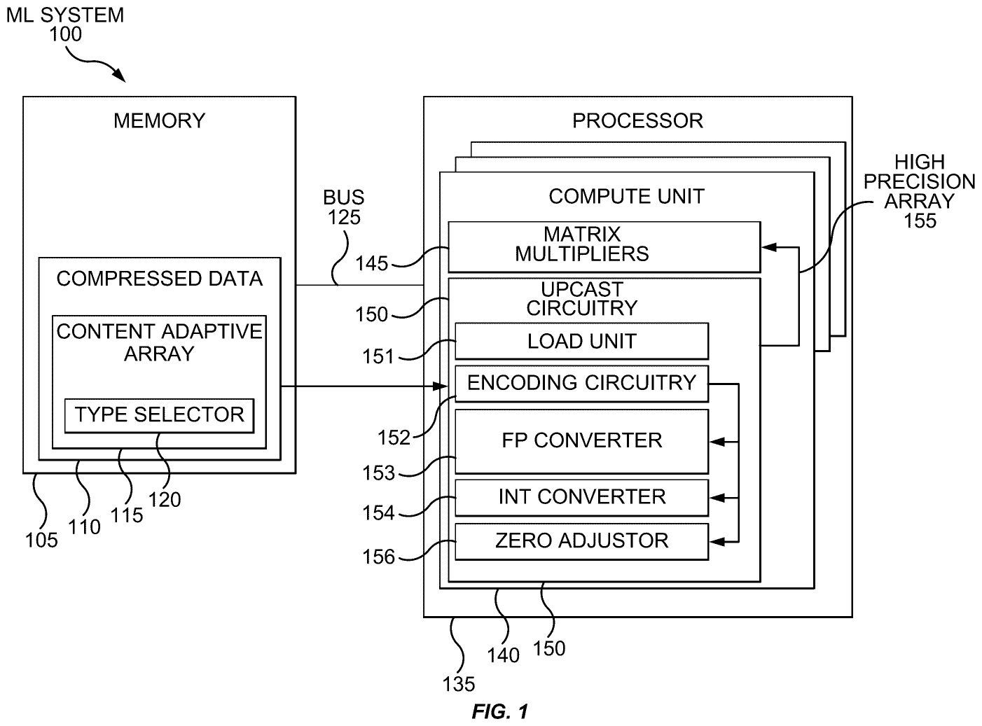

FIG. 1 illustrates a block diagram of a ML compute system 100 for compressing data using a content adaptive array 115, according to one embodiment. While the embodiments herein are discussed in the context of a ML or AI system, they are not limited to such. That is, the content adaptive array 115 could be used in other applications to compress and move data to and from memory, such as distributed computing systems or computing systems that execute parallel computing workloads across multiple nodes.

With ML applications, large amounts of data such as weight tensors, activations, input/output, and the like are frequently moved from memory 105 to compute units 140 that perform ML operations (which often includes matrix multiplications). The memory 105 may be main memory (e.g., RAM), storage (e.g., solid state drives or hard disk drives), as well as any number of cache levels (e.g., L2/L3 cache). The memory 105 is coupled to the processor 135 via a bus 125.

The processor 135 includes compute units 140 for performing the ML operations using the content adaptive array 115. In this example, the compute units 140 include matrix multipliers 145, but this is only one example of circuitry that may be in the compute units 140.

The processor 135 can be a central processing unit (CPU), a graphics processing unit (GPU), a field programmable gate array (FPGA), a system on a chip (SoC) that includes an array of artificial intelligence (AI) engines, and the like. For example, the compute units 140 may be cores in a CPU, or a workgroup or a processing tile in a GPU. The compute units 140 may include vector processors (e.g., single instruction, multiple data (SIMD)) or streaming multiprocessors (SM) and memory (e.g., registers). Moreover, the compute units 140 can be assigned to workgroups by a programmer to execute wavefronts. In other examples, one or more compute units 140 may be assigned to a kernel. If the processor 135 is an FPGA, the compute units 140 may be formed using programmable logic (in contrast to hardened circuitry or hardened logic).

The bandwidth in the bus 125, and the storage in the memory 105 may be limited. As such, it is advantageous to store the content adaptive array 115 using a datatype with smaller bits (e.g., FP4 or INT4 versus FP8, INT8, or FP32). As such, the compressed data 110 uses less space in the memory 105, and uses less bandwidth when traversing the bus 125.

However, it also may be advantageous to convert the compressed data 110 into a high precision array 155 before it is processed in the compute unit 140 (e.g., before performing matrix multiplication using the matrix multipliers 145) since this can improve accuracy. For example, matrix multiplications can be used to perform convolution, linear regression, updating weights during training, etc. Moreover, the matrix multipliers 145 may not be compatible with (or not support) the datatype in the content adaptive array 115. For these reasons, the compute unit 140 includes upcast circuitry 150 (e.g., conversion circuitry) which can convert the compressed content adaptive array 115 into a high precision array 155. This can include changing the data values to datatypes that include more data bits (e.g., FP4 to FP8 or FP32) as well as changing between different categories of datatypes (if necessary) (e.g., from an INT to a FP datatype).

The upcast circuitry 150 includes a load unit 151, encoding circuitry 152, a FP converter 153, an INT converter 154, and a zero adjustor 156. The load unit 151 retrieves the content adaptive array 115 from the memory 105. The load unit 151 can also be tasked with loading the converted (e.g., upcasted) data into registers in the compute unit 140 so the data can be processed by the matrix multipliers 145.

The encoding circuitry 152 can evaluate the content adaptive array to determine what type of upcasting should be performed. To that end, the upcasting circuitry 150 includes the FP converter 153 which includes circuitry for converting FP datatypes and the INT converter 154 which includes circuitry for converting INT datatypes. For example, if the high precision array 155 should include data that is FP8,then if the content adaptive array includes FP4 data, the encoding circuitry 152 routes the data to the FP converter 153 where it is upcast to FP8 data. If the content adaptive array includes INT4 data, the encoding circuitry 152 routes the data to the INT converter 154 where it is upcast to FP8 data.

Moreover, as described below, the content adaptive array can include both FP and INT data (as well as different types of FP or INT data, such as FP4 and FP8, or INT4 and INT8). In that case, the encoding circuitry 152 can route the FP data in the array 115 to the FP converter 153 and the INT data in the same array 115 to the INT converter 154.

Note that while FIG. 1 illustrates using the FP converter 153 and the INT converter 154 to perform upcasting, the techniques herein could be used in downcasting circuitry to downcast high precision datatypes in an content adaptive array 115 into lower precision datatypes before the data is processed by the matrix multipliers 145.

The zero adjustor 156 includes circuitry for adjusting the data using a scale factor. A shared scale factor is discussed in more detail in the figures below.

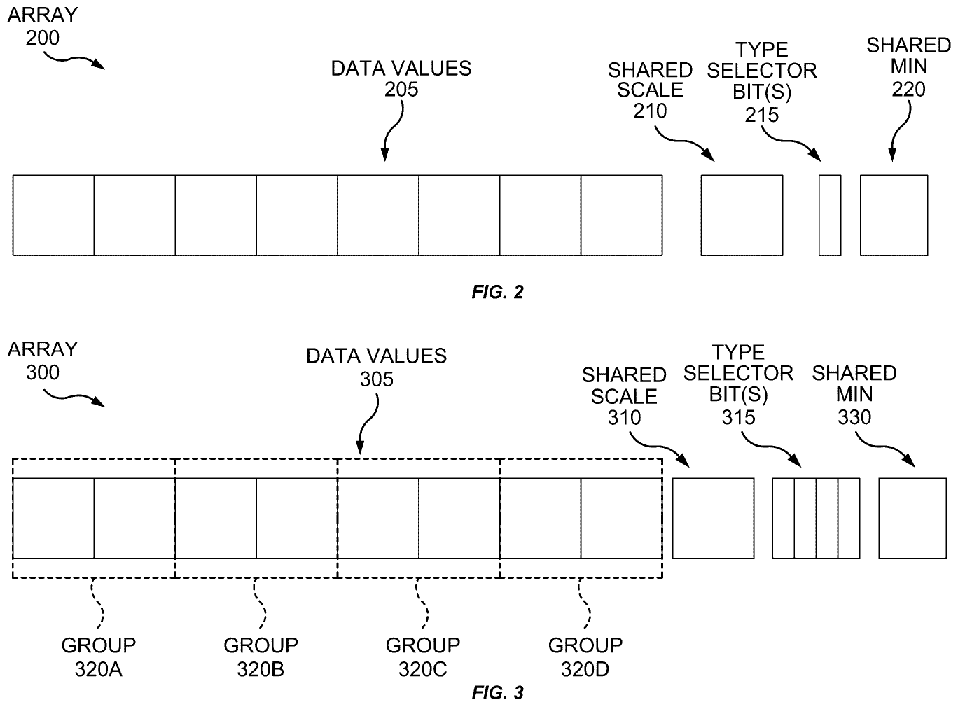

The content adaptive array 115 includes a type selector 120 which can include one or more bits indicating the type of the data values in the array 115. In one embodiment, the type selector 120 is metadata about the data values since it describes the data values but does not directly affect their values (unlike a scale factor or exponent). The encoding circuitry 152 in the upcasting circuitry 150 can use the type selector 120 to determine how to upcast the data values or whether the upcast circuitry 150 should convert the data values to a different type. Put differently, the type selector 120 can inform the encoding circuitry 152 which path the data should be processed in—e.g., a path that includes the FP converter 153 or a path that includes the INT converter 154. Different types of content adaptive arrays 115 are described in FIGS. 2-7.

While FIG. 1 illustrates using the compressed adaptive content array 115 as the transport datatype when moving data into (and out of) the compute units 140, this is just one example. In the ML/AI applicants, the datatypes evolve toward shorter types. The motivation is to perform more operations quicker, and shorter datatypes are easier and faster to operate on

As datatypes get shorter, choosing datatypes for a data array has become increasingly more challenging. The challenge with shorter datatypes is preserving as much information as possible. As such, having greater flexibility when selecting datatypes can result in retaining more information and improving the accuracy of the model.

The datatype choice can depend on the characteristics of the array it represents. The range, distribution, ML model performance, and many other characteristics are important in deciding which datatype would best suit a specific array. To make things even more challenging, these characteristics could also change and evolve as the model is trained. Moreover, different parts of the same array might exhibit different characteristics. As such, adding a type selector 120 that permits array to change to different datatypes, and/or contain multiple different datatypes in the same array 115 can add flexibly to resolve these issues.

FIG. 2 illustrates a 1D content adaptive array 200, according to one embodiment. For example, the array 200 can be a vector that includes data values 205, a shared scale 210, and type selector bit(s) 215. In the context of ML/AI, the data values 205 can be weights, input/output data, activations, etc. In one embodiment, the bits or size of each of the data values 205 is the same. For example, the eight data values 205 may each have four bits. Of course, this is just one example, and the array 200 can be much larger, and the number of bits in each data value 205 can be greater (e.g., 8, 16, 32, etc.).

The shared scale 210 is a value that scales each of the data values 205. For example, the shared scale 210 may serve as a common exponent (or a power of two scale) for the data values 205. The shared scale 210 is especially useful for smaller datatypes (e.g., four bits or less) to help provide additional dynamic range and preserve accuracy. For example, if the datatypes are integers (e.g., INT4), the shared scale 210 can serve as an exponent value for the values 205 when they are upcast.

However, in some cases, the shared scale 210 may be omitted since the data values 205 themselves may have a sufficient number of bits to accurately represents the values. That is, the embodiments herein are not limited to arrays 200 that include data values with a shared scale 210.

The type selector bit can indicate the datatype of the data values 205. For example, if the type selector bit 215 is a single bit, this means the data values 205 could be two different datatypes (e.g., a logical one can indicate the data values 205 are INT4 while a logical zero indicates the data values 205 are FP4). If the type selector bits 215 has two bits, the data values 205 can be four different datatypes (e.g., “00” indicates INT4, “01” indicates FP4, “10” indicates MXFP4, and “11” indicates BFP4). Designating more bits as the type selector bits 215 provides greater flexibility when determining the datatypes. Put differently, the ML system can select from a larger pool of different datatypes for the data values 205 as more bits are assigned to the type selector bits 215.

The array 200 also includes a shared minimum (min) 220. The shared min 220 permits a mean value for the data values to be changed. For example, if each of the data values 205 were three bits, where one bit is a sign, then the data could range from −3 to 3. However, if the data values 205 typically are within the range of 0 to 7, the shared min 220 could be used to shift the zero value (or the mean) to 3. In that case, the data values 205 would have a range of values from 0 to 7. Thus, while the shared scale 210 adjusts the scale of each of the data values 205, the shared min 220 adjusts the mean of the data values 205. However, the shared min 220 is optional, and in some embodiments, the content adaptive arrays may not include a shared min.

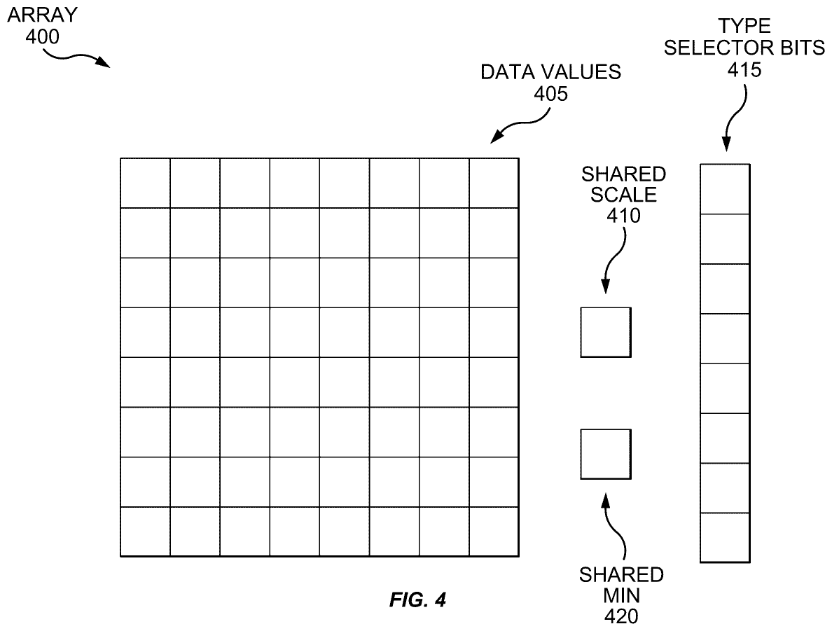

FIG. 3 illustrates a 1D content adaptive array 300 that is divided into groups 320, according to one embodiment. In this example, the array 300 includes eight data values 305 along with a shared scale 310, like the array 200 in FIG. 2. However, these eight data values 305 are divided into four groups 320A-D. The array 300 also includes four type selector bits 315 where each bit corresponds to one of the groups 320. That is, a first bit of the bits 315 indicates the datatype of the data values 305 in group 325A, a second bit of the bits 315 indicates the datatype of the data values 305 in group 325B, a third bit of the bits 315 indicates the datatype of the data values 305 in group 325C, and a fourth bit of the bits 315 indicates the datatype of the data values 305 in group 325D.

While FIG. 3 illustrates two data values in each group 320, in practical implementations, an array 200 would likely have many more data values, which means the groups 320 would be larger. The greater number of data values 305 means the greater likelihood that the dynamic range or distribution of the data values 305 is large which increases the risk of underflow. Dividing the data values 305 into groups 320 reduces the risk of underflow since data values in each group can be assigned to different datatypes. For example, if the data values in group 320A are quite different, then a FP datatype may be used for these values to prevent underflow. However, if the data values in group 320B are similar, a INT datatype may be used to improve accuracy. In this manner, the same array 300 can have data values 305 represented using different datatypes, which is tracked by the type selector bits 315.

In one embodiment, when the array 300 includes data values 305 represented as different datatypes, the data values 305 still have the same number of bits (e.g., the same size). Thus, data values 305 that represent INTs have the same number of bits as data values 305 in the array 300 that are FPs. As such, in this example, the array 300 would not have data values 305 with different numbers of bits or sizes (e.g., FP8 and FP4, or INT4 and FP8). Having consistent sizes of the data values 305 can help the hardware to identify the different data values 305 within the array when processing the array 300.

To support more datatypes, multiple type selector bits can be used for each group 320. For example, the type selector bits 315 can include two bits for each group 320 (8 bits total) so that the ML system can select from four different datatypes. In one embodiment, the number of groups 320 can be balanced with the number of datatypes that the ML system supports. For example, by decreasing the number of groups 320, this means more bits are available to encode additional datatypes. For instance, if the array 300 had two groups 320 rather than four, then two of the bits of the type selector bits 315 can be used to encode the datatypes for each of the two groups, rather than having one bit for each of the four groups shown in FIG. 3.

The array 300 also includes a shared min 330 that permits a mean value for the data values 305 to be changed. However, the shared min 330, like the shared scale 310, is optional.

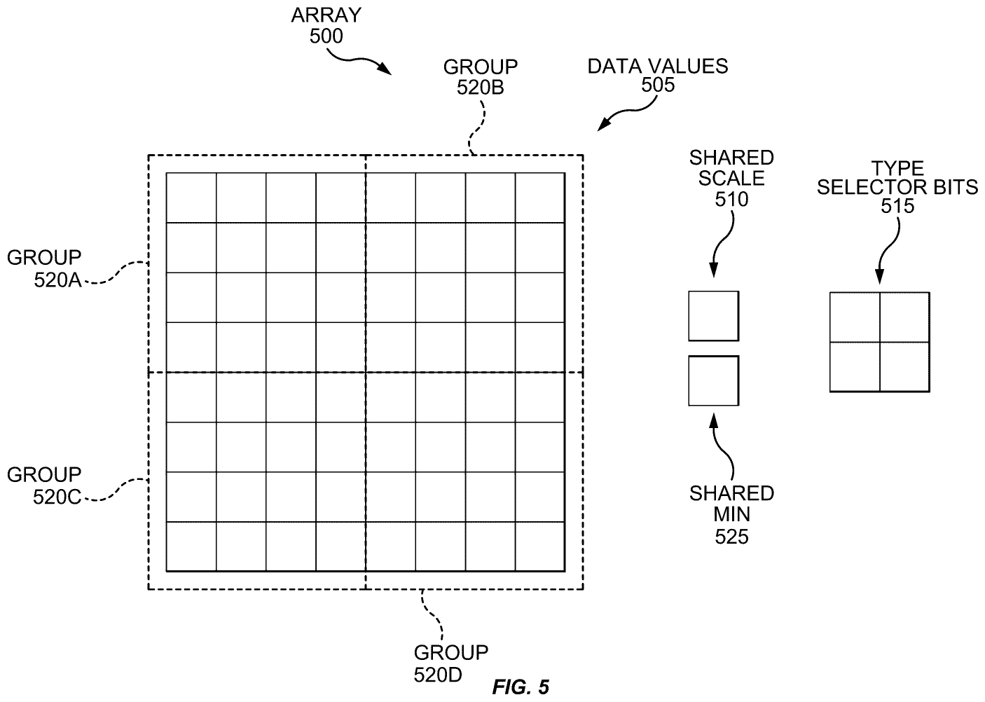

FIGS. 4 and 5 illustrate a 2D content adaptive array that is divided into groups, according to one embodiment. In these figures, the content adaptive array is a matrix (also referred to as a tile) that includes rows and columns of data values.

The content adaptive array 400 in FIG. 4 includes a matrix of data values 405 which are scaled by the shared scale 410. In this example, the array 400 also includes type selector bits 415 for indicating the datatype of each row of the data values 405. Since there are eight rows of data values 405, the type selector bits 415 include at least eight bits where one of the bits indicates the datatype for one of the rows. However, in another embodiment, the type selector bits 415 can indicate the datatype for each column in the matrix.

As discussed above, the type selector bits 415 can include multiple bits for each row so that the ML system can support more than two different datatypes—e.g., using two bits for each row (16 bits total) means that four datatypes could be used, and so forth.

Unlike in FIGS. 2 and 3 where each row has a shared scale, here, the entire matrix of data values 405 uses the same shared scale 410. Thus, the bits saved by not having a shared scale per row can be used for the type selector bits 415 and/or to make the shared scale 410 larger. Thus, each row (or column) of the data values 405 can be assigned a different datatype. Further, multiple type selector bits can be assigned to each row so that additional datatypes can be supported.

Further, while FIG. 4 illustrates having at least one type selector bit 415 for each row, in another embodiment, there may be one or more type selector bits 415 that indicate the datatype for each of the data values 405 in the array 400—i.e., one or more type selector bits 415 for all the data values 405 in the entire array 400. This can be still be advantageous since when the array 400 is first generated, the data values 405 may have similar values, and thus, representing them as INTs may preserve the most information as the array 400 is upcast/downcast. However, over time (e.g., during training), the dynamic range of the values 405 may increase. The ML system may switch to using FP values to represent the data values 405 in order to avoid underflow. Thus, while it may be more accurate to have type selector bits 415 for each row or column, this also uses more bits. Having one or more type selector bits to indicate the datatype for every data value 405 in the array 400 can save bits but still support changing the datatype as the data values 405 change.

Moreover, using the shared scale 410 with a matrix can be especially advantageous during training. On a backward pass of a training step (e.g., when performing back propagation), the inner dimension of the matrix is a different dimension that the tensor which means the shared exponents are not mathematically correct because they are on a different axis. The typical technique to avoid this problem is to quantize to a square tile so the system does have to re-quantize on a backwards pass. The alternative is the ML system would have to take the weights, fetch the original higher precision weights, transpose those, quantize those, and then do the matrix multiply which losses the benefit of using the smaller datatype. Using the shared scale 410 can avoid this re-quantization.

The content adaptive array 500 in FIG. 5 includes a matrix of data values 505 which are scaled by the shared scale 510. In this example, the array 500 also includes type selector bits 515 for indicating the datatype of multiple groups 520 in the array 500 (also referred to as sub-tiles). Since there are four groups 520A-D of data values 505, the type selector bits 515 include at least four bits where one of the bits indicates the datatype for one of the data values 505 in one of the groups 520.

As discussed above, the type selector bits 515 can include multiple bits for each group 520 so that the ML system can support more than two different datatypes—e.g., using two bits for each group (8 bits total) means that four datatypes could be used, and so forth. Thus, FIG. 5 illustrates that the same array 500 (or tile) can be divided into sub-tiles or sub-matrices which can have data formatted in different datatypes.

Like in FIG. 4, here, the entire matrix of data values 505 uses the same shared scale 510. Thus, the bits saved by not having a shared scale per row can be used for the type selector bits 515 and/or to make the shared scale 510 larger. Thus, each group 520 of data values 405 can be assigned a different datatype.

Unlike in FIGS. 2 and 3 where each row has a shared scale, here, the entire matrix of data values 405 in FIG. 4 (and the data values 505 in FIG. 5) uses the same shared min 420 (or shared min 525) for adjusting the mean of the data values. Thus, the bits saved by not having a shared min per row can be used for the type selector bits and/or to make the shared scale larger.

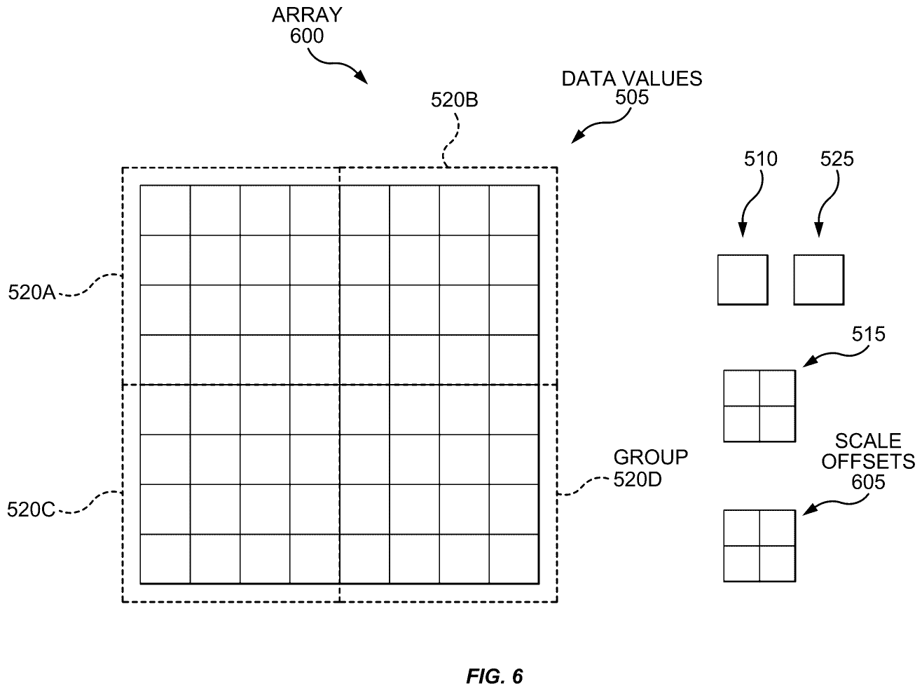

FIG. 6 illustrates a 2D content adaptive array 600 that is divided into groups with additional scale offsets, according to one embodiment. The array 600 is a modified version of the array 500 in FIG. 5, which includes the data values 505, the shared scale 510, the type selector bits 515, and the shared min 525. In addition, the array 600 includes bits reserved for an scale offset 605 that can be applied to each group. That is, the scale offset 605 includes one or more bits for scaling the data values in group 520A, one or more bits for scaling the data values in group 520B, one or more bits for scaling the data values in group 520C, and one or more bits for scaling the data values in group 520D. The scale offset 605 for each group can be used in conjunction with the shared scale 410 (and any local exponent values stored in the data values, if applicable). For example, when upcasting a data value 505, upcast circuitry can scale the bits in the data value (which may or may not include an exponent value) using the group specific scale offset 605 and the shared scale 510 to generate a high precision data value. Stated differently, the per group scale offsets 605 can be stacked with the shared scale 510, along with any scale value or exponent in the data value 505 itself, to scale the data value 505. Thus, FIG. 6 illustrates a hierarchy or scale values or exponents where some exponents apply only to a particular data value 505, some apply only to a particular group or sub-tile, and the shared scale value 510 applies to the entire array 600 or tile.

In another embodiment, the type selector bits 515 can be used to perform the same (or similar) function as the scale offsets 605. For example, the type selector bits 515 can indicate a scaled datatype. For instance, using two bits for each group 520, the type selector bits could indicate whether the data values in the group 520 are FP4 (e.g., FP4 values that are not scaled), FP4 divided by two (e.g., FP4 values that are scaled by two), FP4 divided by 4 (e.g., FP4 values that are scaled by four), or FP8 divided by eight (e.g., FP4 values that are scaled by eight). In this example, the ML system can not only change between different datatypes, but also indicate the scale (on a per group basis) associated with the datatypes, thereby fulfilling the role of the scale offsets 605. In another example, using two bits for each group 520, the type selector bits could indicate whether the data values in the group 520 are INT4 (e.g., INT4 values that are not scaled), INT4 divided by two (e.g., INT4 values that are scaled by two), FP4 (e.g., FP4 values that are not scaled), or FP4 divided by two (e.g., FP4 values that are scaled by two). Thus, the ML system can use the type selector bits to switch between different datatypes, as well as different scales of those datatypes. Of course, by using more type selector bits per group, the ML system can support additional datatypes and different scales of those datatypes.

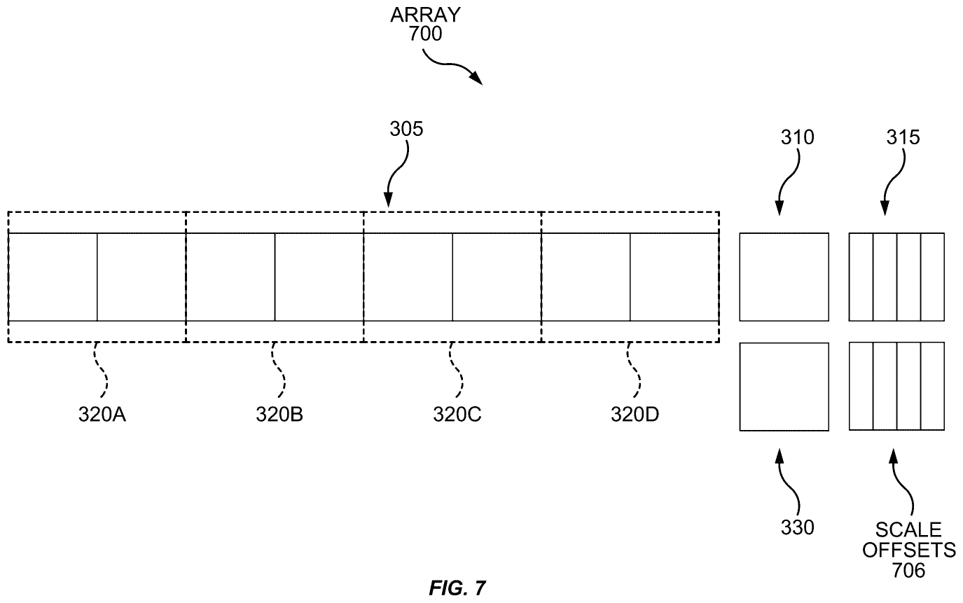

FIG. 7 illustrates a 1D content adaptive array 700 that is divided into groups 320 with additional scale offsets 705, according to one embodiment. The array 700 is a modified version of the array 300 in FIG. 3, which includes the data values 305, the shared scale 310, the type selector bits 315, and the shared min 330. In addition, the array 700 includes bits reserved for an scale offset 705 that can be applied to each group. That is, the scale offset 705 includes one or more bits for scaling the data values in group 320A, one or more bits for scaling the data values in group 320B, one or more bits for scaling the data values in group 320C, and one or more bits for scaling the data values in group 320D. The scale offsets 705 for each group can be used in conjunction with the shared scale 510 (and any local exponent values stored in the data values 305, if applicable). Thus, FIG. 7 illustrates that scale offsets can be applied on a 1D array 700 as well as the 2D array 600 in FIG. 6.

Alternatively, as discussed in FIG. 6, the type selector bits 315 can be used to perform the same (or similar) function as the scale offsets 705. For example, the type selector bits 515 can indicate a scaled datatype (e.g., INT4 divided by two, FP4 divided by four, etc.). In that case, the scale offsets 705 can be omitted.

While FIGS. 2-7 illustrate using 1D or 2D content adaptive arrays, ML/AI applications can have arrays (or tiles) with any number of dimensions. Using type selector bits to indicate the datatype of the data values in the array, or using type selector bits to indicate the datatype of different groups/sub-tiles in the array, can be used regardless of the number of dimensions of the array. As such, the embodiments herein can be used to generate content adaptive arrays that have three, four, five, etc. number of dimensions.

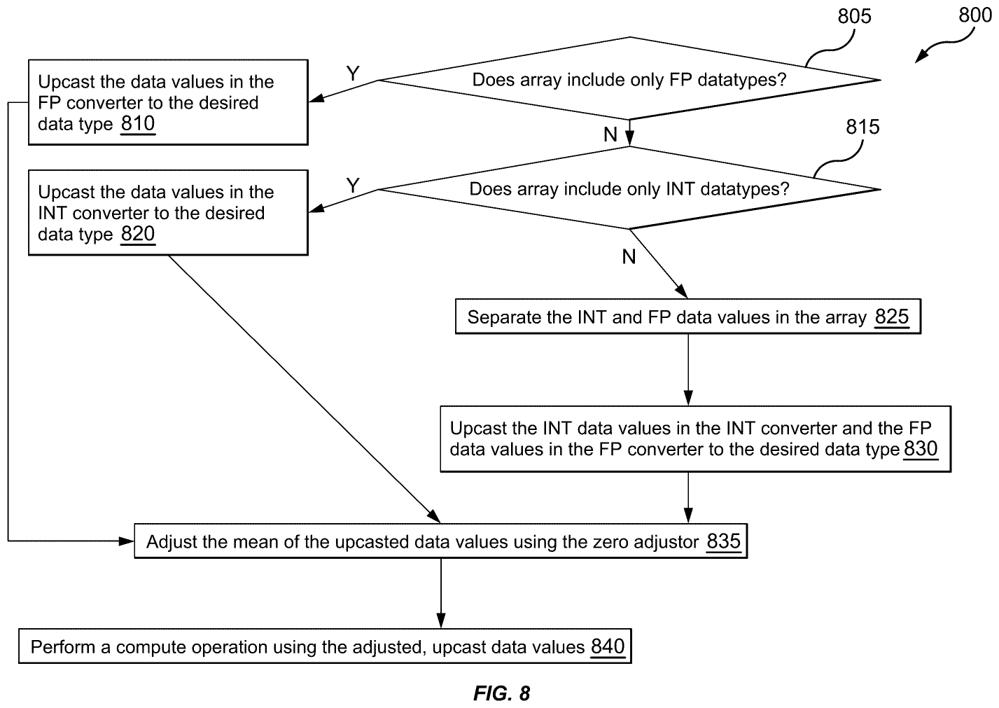

FIG. 8 is a flowchart of a method 800 for upcasting data values in a content adaptive array, according to one embodiment. The method 800 can begin when a load unit in a compute unit (e.g., the load unit 151 in FIG. 1) receives all (or a portion) of a content adaptive array. For example, the load unit may read the entire content adaptive array from memory (assuming the compute unit has sufficient memory/register space), or may read the array in portions or chunks. When reading a portion of the content adaptive array, it is assumed the load unit has access to the metadata corresponding to the data values that have been read from the array—e.g., the type selector bits, shared scale, and shared min.

At block 805, encoding circuitry in the compute unit (e.g., the encoding circuitry 152 in FIG. 1) determines whether the data values in the content adaptive array are only FP values. For example, if the array includes a type selector bit or bits that represent the type of all the data values in the array as is the case in FIG. 2, the encoding circuitry can evaluate that bit(s) to determine if the data values are FP.

However, where the content adaptive array has different type selector bit(s) for different data values (or different groups of data values) in the array as shown in FIGS. 4-7, the encoding circuitry can evaluate the bit(s) for each of the different data values or groups of data values to determine if each is a FP.

If every data value in the array is FP, the method 800 proceeds to block 810 where the encoding circuitry forwards the data values to the FP converter which upcasts the data values to the desired datatype. This datatype can be a datatype that the compute circuitry in the compute unit (e.g., a matrix multiplier) is designed to operate on. The desired datatype could be a INT or an FP. Moreover, the desired datatype can be a higher precision datatype than the datatype of the data values in the array.

However, if not every data value in the array is FP, the method 800 instead proceeds to block 815 where the encoding circuitry determines whether the data values in the content adaptive array are only INT values. As described at block 805, the encoding circuitry can evaluate the type selector bit(s) to determine whether every data value in the array is an INT. If so, the method 800 proceeds to block 820 where the encoding circuitry forwards the data values to the INT converter which upcasts the data values to the desired datatype. This datatype can be the same datatype that FP converter outputs (e.g., both the FP converter and the INT converter may both output FP8 datatypes) and can be a higher precision datatype which the compute unit is designed or configured to process.

However, if the encoding circuitry determines by evaluating the type selector bits that the content adaptive array includes a mix of INT and FP data values, the method 800 proceeds to block 825 where the encoding circuitry separates the INT and FP data values in the array. That is, the encoding circuitry can send the INT data values in the array to the INT converter and the FP data values in the array to the FP converter.

At block 830, the INT converter upcasts the INT data values and the FP converter upcasts the FP data values. Like above, the INT and FP converters can upcast the data values to the same datatype.

In one embodiment, a shared scale (assuming the content adaptive array has a shared scale) is used when upcasting the data values at blocks 810, 820, and 830.

Moreover, the manner in which upcasting is performed can depend on the specific implementation of the FP and INT converter. Some compute units can have separate paths for FP upcasting and INT upcasting (e.g., one path that includes the FP converter and another path that includes the INT converter). In that case, upcasting FP data values can occur in parallel with upcasting the INT data values. However, other implementations may use the same circuit block (or same path) to perform both FP and INT upcasting. In that case, when a content adaptive array has both INT and FP data values, the encoding circuitry may first send the FP data values to the circuit block for FP upcasting and later send the INT data values to the circuit block for INT upcasting.

After upcasting at blocks 810, 820, or 830, the method 800 proceeds to block 835 where the zero adjustor 156 in FIG. 1 adjusts the mean of the upcasted data values. This assumes that the content adaptive array includes a shared min as shown in FIGS. 2-7, which is optional. Moreover, while FIG. 8 illustrates adjusting the mean after performing upcasting, in other embodiments the encoding circuitry may direct the zero adjustor to adjust the mean before performing upcasting.

At block 840, the compute unit performs a compute operation using the adjusted, upcast data values. For example, the content adaptive array may have a mix of FP4 and INT4 data values. The method 800 can use blocks 825 and 830 to upcast these data values to a desired higher precision datatype (e.g., FP8) which a matrix multiplier is designed to operate on. In this manner, the data values can be saved, and transported, using a compressed datatype but then be upcast in the compute unit to a more accurate datatype before being processed. This reduces memory bandwidth, reduces memory requirement, but also preserves accuracy of the compute operations performed by the compute unit. Moreover, because the data values can be upcast to the same data value (or one of select few types of data values), the matrix multiplier does not have to be designed to support a large number of different datatypes.

Moreover, while the method 800 describes saving and storing lower precision datatypes in the content adaptive array and then upcasting them to higher precision datatypes before performing the compute operation, in other scenarios, it may be beneficial to save and store higher precision data values in the content adaptive array and then downcast them to lower precision data values before performing the compute operation. Thus, the embodiments herein are not limited to upcasting data.

Further, after processing the data, the compute unit may include downcasting circuitry for converting the resulting data generated by the compute unit back into lower precision datatype(s) before the content adaptive array is again stored in memory.

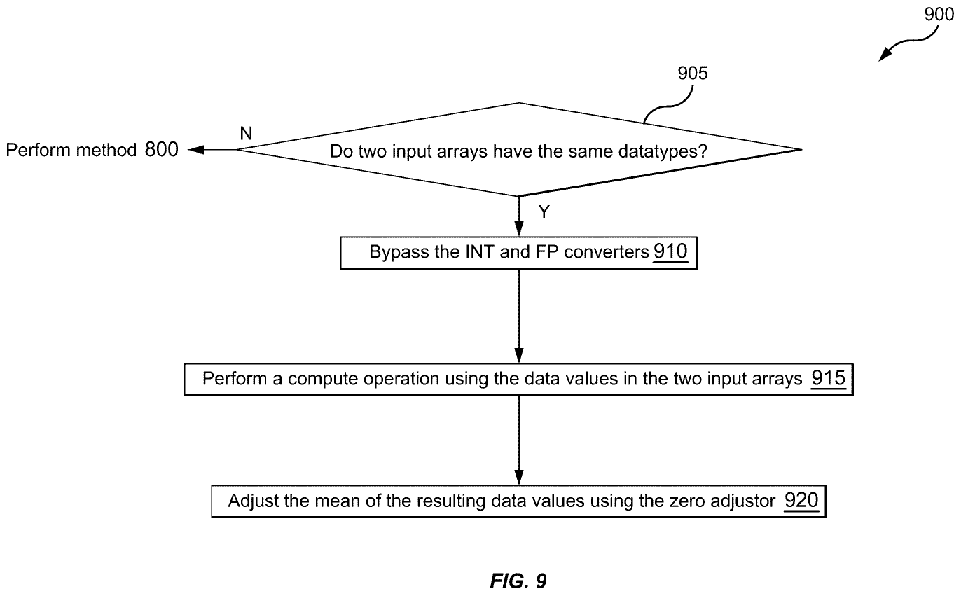

In method 800, the mean is adjusted using the shared min at block 835 before performing the compute operation at block 840. However, FIG. 9 will discuss embodiments where the mean is adjusted after the data values have been processed by the compute circuitry (e.g., a matrix multiplier) in the compute unit.

FIG. 9 is a flowchart of a method 900 for bypassing upcasting in a compute unit, according to one embodiment. The method 900 can begin when a load unit in a compute unit (e.g., the load unit 151 in FIG. 1) receives all (or a portion) of two content adaptive arrays. For example, the load unit may read the entirety of two content adaptive arrays from memory (assuming the compute unit has sufficient memory/register space), or may read portions of the arrays. When reading a portion of the content adaptive arrays, it is assumed the load unit has access to the metadata of the arrays—e.g., the type selector bits, shared scales, and shared min values of the two input arrays.

At block 905, the encoding circuitry determines whether the two input arrays have the same datatypes. For example, the encoding circuitry does not have to read the entire arrays, but can evaluate the type selectors bits of the arrays to determine whether both arrays have the same datatype. This can include the arrays both having the same FP datatype or the same INT datatype. As an example, the compute unit may be asked to perform a matrix multiplication between an array of weights and an array of activations.

If the two arrays do not have data values that are the same, the method 900 proceeds to the method 800, which can be performed on each of the arrays. That is, the method 800 can perform blocks 805-835 to convert the data values in the two arrays to the same datatype before performing block 840 where the adjusted, upcast data values from the two arrays are multiplied.

However, assuming the two arrays have the same datatype, the method 900 can bypass at least one of the INT and FP converters at block 910 for one of the arrays. That is, the encoding circuitry can send the data values for at least one of the arrays directly to the compute circuitry (e.g., a matrix multiplier) without first performing upcasting. The values in the other array may still be processed by the INT or FP converter.

At block 915, the compute unit performs a compute operation using the data values in the two input arrays. That is, the compute unit can multiply the FP data values from one array with the same type of FP data values from the other array, or multiply the INT data values from one array with the same type of INT data values from the other array.

The method 900 can be performed even if the compute circuitry (e.g., the matrix multiplier) is designed to operate on a particular datatype (e.g., FP8). For example, the matrix multiplier can still perform a matrix multiplication of FP4 data values or INT4 data values from two arrays without first upcasting these datatypes.

At block 920, the zero adjustor in the compute unit can adjust the mean of the resulting data values from performing the compute operation at block 915 using the shared min values from the two input arrays. This assumes that the content adaptive arrays include shared min values as shown in FIGS. 2-7, which are optional. Moreover, the compute unit can scale the resulting data values using the shared scale.

In this manner, method 900 illustrates a situation where the encoding circuitry can bypass the upcast circuitry. Moreover, adjusting for the mean using the shared min values in the arrays can be performed after the compute operation (e.g., the matrix multiplication).

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system. ” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. A compute unit, comprising:
encoding circuitry configured to receive an array, the array comprising multiple data values and one or more type selector bits, the one or more type selector bits indicating a datatype of at least one of the data values;
a floating point (FP) converter comprising circuitry configured to convert FP data values in the array to a desired datatype;
an integer (INT) converter comprising circuitry configured to convert INT data values in the array to the desired datatype; and
compute circuitry configured to perform a compute operation using the multiple data values after being converted into the desired datatype.

2. The compute unit of claim 1, wherein the FP converter and INT converter are configured to upcast the data values in the array from a first datatype to a higher precision datatype, wherein the compute circuitry comprises a matrix multiplier configured to perform multiplications when the data values are in the higher precision datatype.

3. The compute unit of claim 2, wherein the array is transmitted from memory to the compute unit when the data values are the first datatype.

4. The compute unit of claim 1, wherein the array comprises a shared minimum (min) value indicating a zero value of the data values in the array, the compute unit further comprising:
a zero adjustor comprising circuitry configured to adjust a mean of the data values based on the shared min value in the array.

5. The compute unit of claim 4, wherein when detecting that two received input arrays have data values with the same datatypes, the encoding circuitry is configured to bypass at least one of the FP and INT convertors when transmitting data values of at least one of the two received input arrays to the compute circuitry,
wherein the zero adjustor is configured to adjust the mean, and scale, data values output by the compute circuitry after processing the data values of the two received input arrays.

6. The compute unit of claim 1, wherein the array comprises both INT and FP data values, wherein the encoding circuitry is configured to:
separate the INT and FP values so that the FP data values are transmitted to the FP converter and the INT data values are transmitted to the INT converter.

7. The compute unit of claim 1, wherein the one or more type selector bits includes a plurality of type selector bits, wherein a first bit of the plurality of type selector bits indicates a first data value of the multiple data values is a first datatype and a second bit of the plurality of type selector bits indicates a second data value of the multiple data values is a second datatype.

8. The compute unit of claim 7, wherein the first bit of the plurality of type selector bits indicates at least two of the multiple data values are the first datatype and the second bit of the plurality of type selector bits indicates at least two of the multiple data values are the second datatype.

9. The compute unit of claim 8, wherein the at least two of multiple data values corresponding to the first bit comprises data values in at least two rows and at least two columns of the array and the at least two of multiple data values corresponding to the second bit comprises data values in at least two rows and at least two columns of the array.

10. The compute unit of claim 1, wherein the array is part of a machine learning (ML) application, wherein the compute circuitry comprises matrix multipliers configured to process the data values.

11. A compute system, comprising:
memory configured to store an array, the array comprising multiple data values and one or more type selector bits, the one or more type selector bits indicating a datatype of at least one of the data values; and
a compute unit configured to:
receive the array from the memory,
convert FP data values in the array to a desired datatype,
convert INT data values in the array to the desired datatype, and
perform a compute operation using the multiple data values after being converted into the desired datatype.

12. The compute system of claim 11, wherein the compute unit is configured to upcast the data values in the array from a first datatype to a higher precision datatype when converting the FP data values and the INT data values to the desired datatype, wherein the compute unit comprises a matrix multiplier configured to perform multiplications when the data values are in the higher precision datatype.

13. The compute system of claim 12, wherein the array is transmitted from memory to the compute unit when the data values are the first datatype.

14. The compute system of claim 11, wherein the array comprises a shared minimum (min) value indicating a zero value of the data values in the array, the compute unit further configured to:
adjust a mean of the data values based on the shared min value in the array.

15. The compute system of claim 14, wherein when detecting that two received input arrays have data values with the same datatypes, the compute unit is configured to bypass converting the FP or INT data values for at least one or the two received input arrays to the desired datatype before performing the compute operation,
wherein the compute unit is configured to adjust the mean, and scale, data values output after performing the compute operation using the data values of the two received input arrays.

16. The compute system of claim 11, wherein the array comprises both INT and FP data values, wherein the compute unit is configured to:
separate the INT and FP values so that the FP data values are transmitted to an FP converter in compute unit and the INT data values are transmitted to an INT converter in the compute unit.

17. The compute system of claim 11, wherein the one or more type selector bits includes a plurality of type selector bits, wherein a first bit of the plurality of type selector bits indicates a first data value of the multiple data values is a first datatype and a second bit of the plurality of type selector bits indicates a second data value of the multiple data values is a second datatype.

18. The compute system of claim 17, wherein the first bit of the plurality of type selector bits indicates at least two of the multiple data values are the first datatype and the second bit of the plurality of type selector bits indicates at least two of the multiple data values are the second datatype.

19. The compute system of claim 18, wherein the at least two of multiple data values corresponding to the first bit comprises data values in at least two rows and at least two columns of the array and the at least two of multiple data values corresponding to the second bit comprises data values in at least two rows and at least two columns of the array.

20. A method, comprising:
receiving an array from memory, the array comprising multiple data values and one or more type selector bits, the one or more type selector bits indicating a datatype of at least one of the data values;
upcasting FP data values in the array to a desired datatype;
upcasting INT data values in the array to the desired datatype; and
performing a compute operation using the multiple data values after being converted into the desired datatype.
